(19) United States
(12) Patent Application Publication
(10) Pub. No.: US 2008/0226852 A1
(43) Pub. Date: Sep. 18, 2008

(54) Gas barrier packaging board

(75) Inventors: Dwayne M. Shearer, Seattle, WA (US); George M. Fox, Longview, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/687,235

(22) Filed: Mar. 16, 2007

(51) Int. Cl. B32B 27/10

(52) U.S. Cl. 428/34.2

(57) ABSTRACT

A paperboard structure having a five layer product side construction with a gas barrier layer which is a blend of nylon and polyethylene terephthalate.

The field is packaging board. More specifically it is a packaging board that may be formed into cartons and cups and has gas barrier properties.

The need for a gas barrier in paperboard packages is well known and there have been many solutions to reduce gas transfer through the paperboard. The amount and rate of gas transfer will depend on the type of barrier layer or layers that is used. The gas barrier layer is either laminated, extruded or co-extruded onto the paperboard to provide a board with gas barrier properties.

There are other factors that enter into the choice of a barrier material. Cost is a factor, both in the type and cost of the barrier material being used and also in the amount required to obtain the necessary barrier properties. Other important factors are carton durability, pinholes, and plastic char. Nylon in direct contact with an extruder die lip generates char (pyrolyzed nylon), and this char must be removed periodically to prevent contamination of the board. Char removal requires shutting down the extruder. The amount of barrier material required is also dependent on the uniformity of the barrier layer in both the machine direction and cross machine direction. Poor uniformity yields thick and thin spots which will change the gas barrier level. The type of material will also determine the amount of power required to extrude the material and therefore is a factor in the total cost of the packaging board.

Another factor is the adhesion of the material to the paperboard. Some materials adhere better than others. Some materials, such as nylon, require special board surface treatment to obtain adhesion to the paperboard. This also is reflected in the cost.

There is also the problem of pinholes. Pinholes are small holes in the plastic film that allow liquid contained in the container to contact and penetrate the paperboard. Wet paperboard is very weak and leads to poor durability and reduced shelf life. Pinholes occur when the plastic film is heated in a sealing operation. Heat generates steam in the paperboard and the steam generates bubbles in the plastic structure. Some of the bubbles burst and form pinholes. The number of pinholes can be greatly reduced if the low density polyethylene or linear low density polyethylene or other polyolefin flows into the bubble area thus sealing any pinholes.

Extrusion or co-extrusion is a faster, lower cost process than lamination. The cost of a laminate film and associated handling is also avoided with co-extrusion.

The present invention is directed to a cost effective gas barrier structure which has five product side layers and uses nylon blended with PET as the gas barrier.

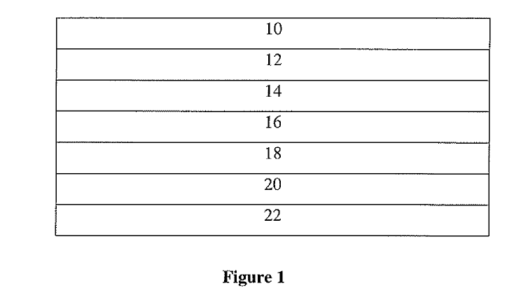

FIG. 1 is a cross-sectional view of the board.

The paperboard 12 has a first side and a second side opposite the first side. The paperboard may have a weight of 200 to 500 g/m².

A polyolefin layer 10 is applied to the outer or first surface of the paperboard 12. A typical outer polyolefin layer 10 is low density polyethylene. Layer 10 provides a good print surface. If improved carton durability is required then linear low density polyethylene, metallocene catalyzed linear low density polyethylene or a blend of low density polyethylene and linear low density polyethylene or metallocene catalyzed linear low density polyethylene may be used. These resins are tougher than low density polyethylene resins. Layer 10 is applied in amounts ranging from 15 to 25 grams per square meter (g/m²).

A polyolefin layer 14 is applied directly to the inner or second surface of the paperboard 12. The polyolefin layer 14 has a first side and a second side opposite the first side. The first side of the layer 14 is applied to the second side of the paperboard 12. The polyolefin layer 14 is usually low density polyethylene. It provides good adhesion to the paperboard without special treatment. If improved carton durability is required then linear low density polyethylene, metallocene catalyzed linear low density polyethylene or a blend of low density polyethylene and linear low density polyethylene or metallocene catalyzed linear low density polyethylene may be used. These resins are tougher than low density polyethylene resins. The amount of layer 14 may range from 4 to 25 grams per square meter. The polyethylene also eliminates the exposure of the nylon to the die lip during an extrusion or co-extrusion process. Die lip contact leads to char which causes waste and downtime.

A first tie layer 16 is applied directly to the polyolefin layer 14. The first tie layer has a first side and a second side opposite the first side. The first side of the tie layer 16 is applied directly to the second side of layer 14. The first tie layer 16 may be any appropriate adhesive resin. A typical adhesive resin is a maleic anhydride modified polyethylene resin. Dupont Bynel® can be used. The usual amount of tie resin would be 3 to 9 grams per square meter.

The gas barrier layer 18 is applied directly to the first tie layer 16. The gas barrier layer 18 has a first side and a second side opposite the first side. The first side of layer 18 is applied directly to the second side of layer 16. The gas barrier layer is a blend of nylon and polyethylene terephtahalate (PET). The nylon can be an aliphatic nylon, an aromatic nylon, an amorphous nylon or blends of any of these. Examples of aliphatic nylons that may be used are nylon 6, nylon 66, nylon 6/66, nylon 6/9, nylon 6/10, nylon 11 and nylon 12. An example of an aromatic nylon is MXD6. An example of an amorphous nylon is Dupont Selar®. The amount of nylon ranges from 5 to 15 grams per square meter. The amount will determine the gas barrier property.

A second tie layer 20 is applied directly to the gas barrier layer 18. The second tie layer has a first side and a second side opposite the first side. The first side of the tie layer 20 is applied directly to the second side of layer 1S. The second tie layer 20 may be any appropriate adhesive resin. It can be the same as the first tie layer. The usual amount of tie resin would be 3 to 9 grams per square meter.

An inner polyolefin layer 22 is applied directly to the tie layer 20. The inner polyolefin layer has a first side and a second side. The first side of the polyolefin layer 22 is applied directly to the second side of tie layer 20. The inner polyolefin product contact layer 22 is usually low density polyethylene. If higher durability is required then linear low density polyethylene, metallocene catalyzed linear low density polyethylene or a blend of low density polyethylene and linear low density polyethylene or metallocene catalyzed linear low density polyethylene may be used. The amount of polyethylene may range from 12 to 25 grams per square meter.

Although preferred embodiments of the invention have been described using specific terms, such description is for illustrative purposes only. The words used are words of description rather than of limitation. It is to be understood that changes and variations may be made by those of ordinary skill in the art without departing from the spirit or scope of the present invention, which is set forth in the following claims. The spirit and scope of the appended claims should not be limited to the description of the preferred versions contained herein.

1. A paperboard with gas barrier properties comprising
paperboard having a first side and a second side opposite the first side,
a first polyolefin layer having a first side and a second side opposite the first side, the first polyolefin first side being applied directly to the second side of the paperboard,
a first tie layer having a first side and a second side opposite the first side, the first tie layer first side being applied directly to the second side of the first polyolefin layer,
a gas barrier layer having a first side and a second side opposite the first side, the gas barrier layer first side being applied directly to the second side of the first tie layer second side, the gas barrier material comprising a blend of nylon and polyethylene terephalate
a second tie layer having a first side and a second side opposite the first side, the second tie layer first side being applied directly to the second side of the gas barrier layer, and
a second polyolefin layer having a first side and a second side opposite the first side, the first side being applied directly to the tie layer second side.

2. The paperboard of claim 1 wherein the first polyolefin layer, the first tie layer, the gas barrier layer, the second tie layer and the second polyolefin layer are co-extruded.

3. The paperboard of claim 1 wherein the polyolefin layers are low density polyethylene.

4. The paperboard of claim 1 wherein the gas barrier is a blend of PET with at least one of an aliphatic nylon, an aromatic nylon, or an amorphous nylon.

5. The paperboard of claim 1 wherein the gas barrier is a blend of PET with a blend of at least two of an aliphatic nylon, an aromatic nylon and an amorphous nylon.

6. The paperboard of claim 1 further comprising a third layer of polyolefin having a first side and a second side, the first side of the third polyolefin layer being attached directly to the first side of the paperboard.
